(19) United States
(12) Patent Application Publication
(10) Pub. No.: US 2026/0203696 A1
(43) Pub. Date: Jul. 16, 2026

(54) A SYSTEM AND METHOD OF MONITORING AND AUTHENTICATING ACTIVITIES OF A COMMERCIAL ESTABLISHMENT

(71) Applicant: Abdullah Ali ALMAROUF, Riyadh (SA)

(72) Inventor: Abdullah Ali ALMAROUF, Riyadh (SA)

(21) Appl. No.: 19/127,776

(22) PCT Filed: May 2, 2024
(86) PCT No.: PCT/IB2024/054234

§ 371 Date: May 7, 2025

(30) Foreign Application Priority Data
May 3, 2023 (IN) 202341031578

(51) Int. Cl. G06Q 10/0639; G06Q 20/20; G06Q 30/015; G06Q 30/018; G06V 20/52

(52) U.S. Cl. CPC G06Q 10/0639; G06Q 20/201; G06Q 30/015; G06Q 30/018; G06V 20/52

(57) ABSTRACT

The present disclosure provides a system and method of monitoring and authenticating activities of an establishment. The method includes the following steps. First, capturing (301) a real-time video inside an establishment, by a plurality of video capturing means, then identifying (302) products and/or service offered to a customer in the establishment based on the captured video, by a cloud server. Next, authenticating (303) the products and/or services offered based on the identification and a request of the products and/or service submitted by the customer, by the cloud server, and authenticating (304) bill received from a point of sale device by comparing with a determined value for the identified products and/or services offered to the customer, by the cloud server. Finally, evaluating (305) employees of the establishment by monitoring the captured video based on parameters, by the cloud server.

### FIELD

The embodiments herein generally relate to monitoring and authentication of activities in a commercial establishment. More particularly, the disclosure relates to a system and method for automated real-time monitoring and authenticating activities of a commercial establishment using video capturing devices.

### BACKGROUND AND PRIOR ART

Technology plays an important role in the field of monitoring and surveillance. Most of the existing businesses and commercial establishments have some form of surveillance for providing security to the people and monitoring the premises in real time. Generally, Closed Circuit televisions are used for real-time video monitoring and surveillance of the premises.

However, these CCTVs are incapable of authenticating the work being performed in these commercial business establishments. Various instances such as transacting a different quantity of products, incorrect price determination, serving a different food item from the order, keep occurring due to manual errors and other circumstances. Further, continuous supervision on each of the activities being performed in such business establishments is not possible solely through manual means. Furthermore, the functions that are performed manually in most of the existing business and commercial establishments are not verified or authenticated, thereby resulting in errors and other inevitable mistakes.

Therefore, there is a need for system to monitor and authenticate activities of a commercial establishment. Moreover, there is a need for a system and method of real-time monitoring and authenticating of activities of a commercial establishment utilizing real-time video capturing means.

### OBJECTS

Some of the objects of the present disclosure are described herein below:

The main objective of the present disclosure is to provide a system and method of real-time monitoring and authenticating activities of a commercial establishment.

Another objective of the present disclosure is to provide a system and method of monitoring and authenticating activities of a commercial establishment using video capturing means.

Still another objective of the present disclosure is to provide a cost-effective system and method of monitoring and authenticating activities of a commercial establishment with minimal human intervention.

Yet another objective of the present disclosure is to provide a system and method of monitoring and authenticating activities including products and/or services offered to a customer, nature of product including colour, size, quantity, pricing of the offered products and/or services and employee performance.

Still another objective of the present disclosure is to provide a system and method for generating a report of the commercial establishment for facilitating remote monitoring through an user device of an owner.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a system and method of monitoring and authenticating activities of a commercial establishment.

In accordance with an embodiment, the system includes a plurality of devices including one or more video capturing devices placed in an establishment. A local server is optionally connected to the devices. A cloud server is connected to the local server and the devices through a communication network. A user device is connected to the cloud server through the communication network. In accordance with an embodiment, the video capturing devices are provided for capturing real-time 360° video inside the establishment, performing three dimensional rendering and transmitting to the cloud server and the user device. The cloud server includes a video monitoring and processing, for processing the captured video based on parameters and an artificial intelligence unit for updating the parameters for processing the captured video. The parameters are based on a product and/or service identification, a product and/or service authentication, a product management and planning, a price authentication, a price determination, an employee monitoring, and an employee evaluation.

In an embodiment, the video monitoring and processing performs identification of products and/or services offered to customer, authentication of the offered products and/or services and automating management of inventory.

In an embodiment, the video monitoring and processing can determine a value of identified products and/or services offered to the customer, authenticate price transmitted by a point of sale device by comparing with price of the products and/or services offered to the customer.

In accordance with an embodiment, the system for monitoring employees in a establishment can comprise the following. A plurality of video capturing units for capturing video of the establishment, a detection means for detecting request raised by a customer in the establishment, a point of sale device generating a bill including the value of the product and/or service offered to the customer, a server in communication with the video capturing units, the detection means, and the point of sale device. The server can include a video monitoring and processing engine, wherein the video monitoring and processing engine including but not limited to the following. An identification unit configured to identify the product and/or service based on the request received from the detection means, and configured to identify the product and/or service offered to the customer based on the captured video. A determination unit configured to determine a final value for the identified product and/or service. An authentication unit configured to authenticate the product and/or service offered by comparing with the identified product and/or service requested, and the authentication unit configured to authenticate the value in the generated bill by comparing with the determined value. An employee evaluation unit configured to evaluate an employee based on the authentication performed by the authentication unit.

In an embodiment, the detection means including an audio capturing device for capturing audio of the request raised by the customer.

In an embodiment, the determination unit configured to determine the final value based on value of each of the identified product and/or service stored in a database, and pre-defined parameters for the product and/or service stored in the database, wherein the pre-defined parameters including but not limited to time, duration of service, employee offering the product and/or service.

In an embodiment, the video monitoring and processing unit including an employee monitoring unit, wherein the employee monitoring unit configured to detect employees from the captured video, and identify characteristics of the detected employees from the captured video, wherein the characteristics including but not limited to movement of the employee, authentication of the employee, number of sales made by the employee, value of the products and/or services handled by the employee, number of customer interactions. The employee evaluation unit configured to evaluate the employee based on the identified characteristics received from the employee monitoring unit and the authentication received from the authentication unit.

In an embodiment, the database configured to store a plurality of images of the products and services offered by the establishment, and pre-defined variables of the services for facilitating identification, wherein the variables including duration of service, output of service. In an embodiment, the identification unit configured to identify products offered to the customer by image processing of the captured video and comparing with images stored in the database, and identify services offered to the customer by identifying the parameters in the captured video.

In an embodiment, the video monitoring and processing engine including a database configured to store output received from the identification unit, determination unit, authentication unit, and employee evaluation unit, and an artificial intelligence unit configured to update the identification unit to increase speed of identification based on the identified images of the product and/or service, and the identified audio of the request from the customer stored in the database.

In an embodiment, the video monitoring and processing engine including a product management and planning unit, wherein the product management and planning unit configured to: include inventory of the products and/or services of the establishment, and update the inventory based on the products and/or services offered to the customer.

In an embodiment, the request can include a list of products and/or services, quantity of products, duration of service.

In an embodiment, a weighing device is configured to transmit a measured weight of the product offered to the customer, and the authentication unit authenticating the measured weight based on quantity of the product detected in the request raised by the customer.

In an embodiment, the server is a cloud server communicating with the video capturing device, detection means, point of sale device through a communication network, and the communication network including Wi-Fi.

In an embodiment, a user device is connected to the server through a communication network, and the user device is configured to facilitating remote access to the video monitoring and processing engine for monitoring employees of the establishment.

In an embodiment, a report generation unit is provided for generating a daily report based on the generated bills received from the point of sale device, data received from the employee monitoring unit, and data received from the employee evaluation unit. The daily report can include but not limited to number and quantity of the products and/or services sold to the customer, and value and mode of the payment received from the customer based on the plurality of generated bills, amount of working and non-working time of the employees, and entry time and exit time of the employees based on the data from the employee monitoring unit, and performance of the employees for the day based on the data from the employee evaluation unit. In an embodiment, the report generation unit can transmit the daily report to a user device for facilitating remote monitoring of the establishment.

In accordance with an embodiment, the method for monitoring employees in a establishment can comprise the following steps. First, capturing video of a establishment, by a plurality of video capturing means, then detecting request raised by a customer in the establishment, by a detection means, then, transmitting the captured video and the detected product and/or service to a video monitoring and processing engine in a server, then, transmitting a bill including the value of the product and/or service offered to the customer to the video monitoring and processing engine, by a point of sale device. The video monitoring and processing engine is configured for identifying the product and/or service requested by the customer based on the request detected by the detection means, identifying the product and/or service offered to the customer based on the captured video, detected by the detection means, determining a value for the identified product and/or service, authenticating the product and/or service offered by comparing with the identified product and/or service requested, authenticating the value in the generated bill by comparing with the determined value, and evaluating the employee based on the authentication performed by the authentication unit. Finally, generating a report of the establishment for transmitting to a user device for facilitating remote monitoring, by the cloud server.

In an embodiment, an artificial intelligence unit configured for updating the identification unit to increase speed of identification based on identified images of the product and/or service, and identified request from the customer stored in a database.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a system of monitoring and authenticating activities of a commercial establishment, according to an embodiment herein;

FIG. 2 illustrates a block diagram of a system of monitoring and authenticating activities of a commercial establishment, according to an exemplary embodiment herein; and

FIG. 3 illustrates a flow chart of a method of monitoring and authenticating activities of a commercial establishment, according to an embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

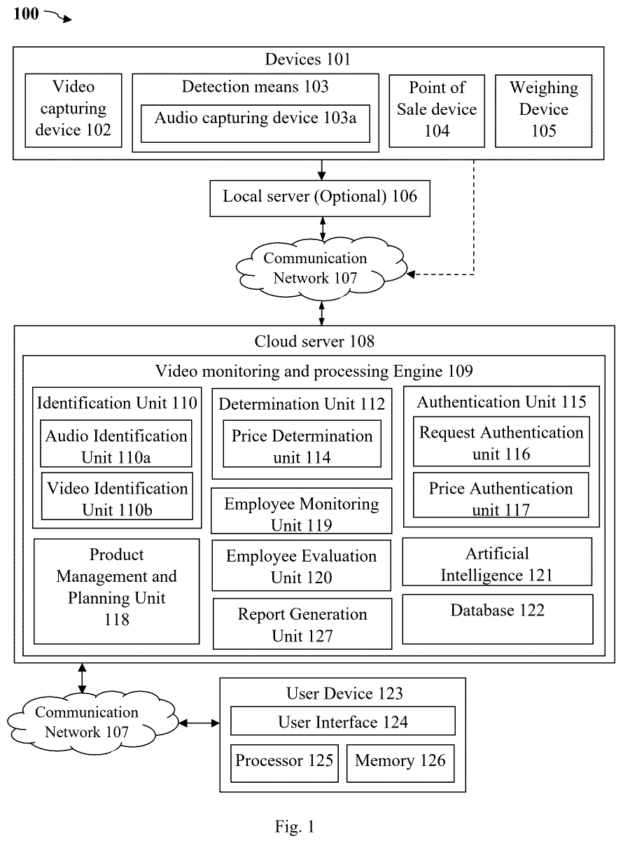

As mentioned above, there is a need for there is a need for system to monitor and authenticate activities of a commercial establishment. In particular, there is a need for a system and method of real-time monitoring and authenticating of activities of a commercial establishment utilizing real-time video capturing means. The embodiments herein achieve this by providing “A System and Method of Monitoring and Authenticating Activities of a Commercial Establishment”. Referring now to the drawings, and more particularly to FIG. 1 through FIG. 3, where similar reference characters denote corresponding features consistently throughout the figures, there are shown preferred embodiments.

FIG. 1 illustrates a block diagram of a system of monitoring and authentication. In an embodiment, the system includes a plurality of devices 101, a cloud server 108 and a user device 123. In an embodiment, the plurality of devices 101 is placed in a commercial establishment. The commercial establishment can include but not limited to a place dealing with goods and/or services including restaurants, supermarkets, salons, shops, grocery stores, marts.

In an embodiment, the devices 101 necessarily include a plurality of video capturing devices 102, and a point of sale device 104. The video capturing devices 102 are fixed at plurality of locations in the commercial establishment for continuously capturing a video inside the commercial establishment. The video capturing device 102 can include but not limited to a camera. In an embodiment, the video capturing device 102 can include a 360° camera for capturing a 360 degree video of the commercial establishment. The video capturing device 102 can provide a three dimension rendering of the captured video. The captured three dimensional 360° view video of the commercial establishment can be transmitted to the user device 123 for remote monitoring and the cloud server 108.

In an embodiment, the video capturing device 102 can include but not limited to a camera.

In an embodiment, the point of sale device 103 can include but not limited to a card swiping machine, a QR code machine, a billing system including cash register.

In an embodiment, a detection means 103 is provided for detecting request raised by a customer in the commercial establishment. The detection means 103 can include but not limited to an audio capturing device 103a. The audio capturing device 103a can include a microphone for capturing an audio of the request raised by the customer.

In an embodiment, the devices 101 can include but not limited to a weighing device 104 (in grocery shops), based on the commercial establishment.

In an optional embodiment, a local server 106 is connected to the devices 101 present in the commercial establishment. The local server 106 can include a processor and a memory. In an embodiment, data from the devices 101 is transmitted to the local server 106. In an embodiment, the local server 106 is provided for submitting input including details of the products and/or services. The details can include but not limited to pricing of the products and/or services, inventory of the products, list of services being offered.

In an embodiment, data from the devices 101 can include but not limited to video of the commercial establishment captured by the video capturing means, details of the bill stored by the point of sale device 103, and weight of products measured by the weighing device 104. The local server 106 transmits the data received from the devices 101 to a cloud server 108, through a communication network 107.

In an embodiment, the local server 106 can include but not limited to an electronic communication device including computer, smart phone, laptop. In an embodiment, the communication network 107 can include but not limited to internet.

In an embodiment, the cloud server 108 can be configured for processing the data of the devices 101. In an embodiment, the cloud server 108 can include but not limited to a video monitoring and processing engine 109.

In an embodiment, the video monitoring and processing engine 109 can include but not limited to a product and/or service identification unit 110 including an audio identification unit 110a, and a video identification unit 110b, a determination unit 112 including a price prediction unit 113, and a price determination unit 114, a product and/or service authentication unit 115 including a request authentication unit 116, and price authentication unit 117, a product management and planning unit 118, an employee monitoring unit 119, an employee evaluation unit 120, an artificial intelligence unit 121, and a database 122.

In an embodiment, the product and/or service identification unit 110 is provided for identifying products and/or services requested by a customer and the product and/or service offered to a customer.

In an embodiment, the audio identification unit 110a can identify the product and/or service from the detected audio of the request raised by the customer.

In an embodiment, the video identification unit 110b can identify the product and/or service offered to the customer based on the captured video. The video identification unit 110b can perform image processing for identifying a presence of a customer and identifying the product and/or service being offered to the customer. In an embodiment, the video identification unit 110 can identify nature of the product including but not limited to colour, size, quantity, type. The identified products and/or services offered to the customers are transmitted to the product and/or service authentication unit 115, and determination unit 112.

In an exemplary embodiment, where the commercial establishment is a restaurant, the product and/or service identification unit 110 identifies food being served to the customer. The product and/or service identification unit 110 identifies each of the food item being served to each of the customer, by an employee of the restaurant, and identifies the employee serving the customer. The identified food items, details of the employee and the customer are transmitted to the product and/or service authentication unit 115.

In another exemplary embodiment, where the commercial establishment is a salon, the product and/or service identification unit 110 identifies services being offered to each of the customer including type of haircut. The identified services of the customer are transmitted to the product and/or service authentication unit 115.

In an embodiment, the price determination 113 can determine value for the identified products and/or service offered to the customer. The price determination 113 determines the value based on price of each of the identified products and/or services and pre-defined parameters for the product and/or service stored in the database. The pre-defined parameters can include but not limited to time of service, employee offering the service, duration of service, employee offering the product and/or service

In an embodiment, the price determination 113 can transmit the determined value to the user device 123. In another embodiment, the price determination unit 114 can transmit the determined value to the point of sale device, and a bill for the customer is generated based on the value determined by the price determination unit 113.

In another embodiment, the price determination unit 114 can predict pricing of a service based on parameters and input received from the artificial intelligence unit 121. In an embodiment, the parameters can include but not limited to duration of a service, details of employee providing a service, time and day of service.

In an embodiment, the product and/or service authentication unit 115 can include a request authentication unit 116, and a price authentication unit 117.

The request authentication unit 117 can authenticate the products and/or services being offered to the customer by an employee, based on the products and/or services requested by the customer. In an embodiment, the request authentication unit 116 compares nature of products and/or services requested by the customer, received from the audio identification unit 110a with the identified products and/or services offered to the customer, received from the video identification unit. In another embodiment, the product and/or service authentication unit 115 can receive data of products and/or services requested by the customer from an ordering device/system in the commercial establishment.

On determining that the products and/or services offered to and requested by the customer are same, the request authentication unit 115 authenticates the transaction of the customer. On determining that the products and/or services offered to and requested by the customer are not same, the request authentication unit 115 transmits an alert to the user device 123 of the owner.

In an embodiment, the price authentication unit 117 is configured for receiving bill details of the customer from the point of sale device 103. The price authentication unit 117 can authenticate the value of the bill by comparing the value quoted in the bill with the value determined by the price determination unit 114.

On identifying the value determined and the value quoted in the bill as same, the price authentication 112 authenticates the value. On identifying the value determined and the value quoted in the bill as not same, the price authentication 112 transmits an alert to the user device 123 of the owner.

In an embodiment, the authentication unit 115 receives the identified products and/or services offered to the customer from the product and/or service identification unit 110.

In an embodiment, the product and/or service authentication unit 115 transmits authentication of products and/or services offered to a customer and offered by an employee, to the product management and planning unit 118, and the employee evaluation unit 160.

In an embodiment, the product management and planning unit 118 is provided for managing inventory of the commercial establishment based on data received from the devices 101 and authentication received from the product and/or service authentication unit 115. The product management and planning unit 118 adjusts quantity of existing products, analyses trends of sold products and provides forecasts and planning for managing the products of the commercial establishments based on authenticated transaction of the products.

In an exemplary embodiment, where the commercial establishment is a salon, the price determination unit 114 can predict pricing for a haircut performed on the customer based on duration taken for the cut, details of barber performing the haircut. On determining increased duration, and an experienced barber having a high salary performing the haircut, the price determination unit 114 determines the price and transmits to the user device 123.

In an embodiment, the employee monitoring unit 119 can be provided for monitoring employees of the commercial establishment. In an embodiment, the employee monitoring 115 can identify employee from the captured video for monitoring the employee. The employee monitoring unit 119 receives authentication details related to the employee from the product and/or service identification 110 of products and/or services handled by the employee. In an embodiment, the employee monitoring 115 monitors the employees based on characteristics. The characteristics for monitoring are pre-defined and set in the cloud server 108.

In an embodiment, the characteristics can include but not limited movement of the employee, authentication of products and/or services handled by employee, number of sales made by the employee, value of the products and/or services handled by the employee, number of customer interactions.

In an embodiment, the employee monitoring unit 119 can transmit the monitored data of each of the employees to the employee evaluation unit 120.

In an embodiment, the employee evaluation unit 120 is provided for evaluating the employees based on the monitored data. The employee evaluation 120 can evaluate performance of each of the employees in the commercial establishment based on the monitored data including identified characteristics received from the employee monitoring unit 119, and the authentication received from the authentication unit 115. The evaluation can include but not limited to classifying the employee as hard worker, normal worker and lazy worker.

In an exemplary embodiment, the employee valuation unit can identify the employee as hard worker based on movement of the employee, number of sales made by the employee, value of the products and/or services handled by the employee, number of customer interactions and number of authenticated products and/or services handled by employee greater than a threshold number, the employee valuation unit can identify the employee as normal worker based on movement of the employee, number of sales made by the employee, value of the products and/or services handled by the employee, number of customer interactions and number of authenticated products and/or services handled by employee equal to a threshold number. The employee valuation unit can identify the employee as lazy worker based on movement of the employee, number of sales made by the employee, value of the products and/or services handled by the employee, number of customer interactions and number of authenticated products and/or services handled by employee less than a threshold number.

In an embodiment, a database 118 is provided for storing data received from the devices 101 and data received from the video monitoring and processing engine 109. In an embodiment the database 122 can be configured to store a plurality of images of the products and services offered by the commercial establishment, and pre-defined variables of the services for facilitating identification. The pre-defined variables can include but not limited to duration of service, output of service.

In an embodiment, the identification unit 110 can be configured to identify products offered to the customer by image processing of the captured video and comparing with images stored in the database, and identify services offered to the customer by identifying the variables in the captured video and comparing with the services stored in the database.

In an embodiment, the artificial intelligence unit 121 can update each of the product and/or service identification unit 110, determination unit 112, product and/or service authentication unit 115, product management and planning unit 118, employee monitoring unit 119, and employee evaluation unit 120. The artificial intelligence unit 121 can update parameters based on the historical data received from the database 118 for accurately performing monitoring and authentication.

In an embodiment, the artificial intelligence unit 121 can increase speed of identification based on the identified images of the product and/or service, and the identified audio of the request from the customer stored in the database.

In an exemplary embodiment, the artificial intelligence unit 121 can transmit parameters for automating the price prediction determination 114 or services generally offered to the customer.

In an embodiment, the user device 123 is connected to the cloud server 108 using the communication network 107. The user device 123 is provided for facilitating remote monitoring of the commercial establishment by an owner/employer. The user device 123 includes a user interface 119, wherein the user interface 119 facilitates the user in accessing the cloud server 108 for remote monitoring of the commercial establishment.

In an embodiment, the user device 123 can include a processor 121 and a memory 122. In an embodiment, the user device 123 can include but not limited to a smart phone, laptop, any electronic communication device.

In an embodiment, the video monitoring and processing engine 109 can include a report generation unit 127 for generating a daily report of the commercial establishment based on data received from the point of sale device 104, and the video monitoring and processing engine 109 including the identification unit 110, the employee monitoring unit 119, and the employee evaluation unit 120.

In an embodiment, the daily report can include but not limited to events in the commercial establishment, price and quantity of products and/or services sold, value of payment and mode of the payment received from the customers, employee working pattern and employee performance. The identification unit 110 transmits customer interaction, and other identified events from the captured video. The point of sale device 104 transmits the number and quantity of the products and/or services sold, the amount received from the customer and the mode of the payment based on the plurality of generated bills. The employee monitoring unit 119 transmits the identified employee, time of working of each employee, entry time and exit time of each employee, and time of non-working of each employee. The employee evaluation unit 120 transmits the performance of the employees for the day. The report generation unit 127 can generate the daily report based on the data received from the point of sale device 104, and the video monitoring and processing engine 109. In an embodiment, the report generation unit 127 generates ann yearly report by consolidating and combining all the daily reports of the year.

The report generation unit 127 can transmit the daily report and the yearly report to the user device 123.

The user can access the daily report and the yearly report through the user interface 124 in the user device 123 for remote monitoring the commercial establishment.

The system can include plurality of embodiments based on different combination of the devices and functionality of the video monitoring and processing engine 109. For example, the embodiments can include a first embodiment relating to commercial establishments offering services, a second embodiment relating to commercial establishments offering quantity-based goods and restaurant services, and a third embodiment relating to commercial establishments offering goods. The embodiments can benefit the government in preventing tax evasion, commercial concealment, money laundering and price manipulation from commercial establishments. The embodiments can benefit the commercial establishments by monitoring the performance of workers and employees, monitoring financial fraud committed by workers and employees, monitoring thefts by visitors in stores, performing storage monitoring, and monitoring the working hours of workers and employees and their performance.

In an exemplary first embodiment, the commercial establishment can include a laundry shop. The video capturing device 102 can capture complete video inside the laundry shop. The video identification unit 110b in the cloud server 108 can identify number of washing machines performing services on different clothes (dress, garment, pants, short, trousers, skirt, blouse, dress) of a customer. The video identification unit 110b can determine all the services performed in the laundry shop.

In another exemplary first embodiment, the commercial establishment can include a car wash shop. The video capturing device 102 can capture complete video inside the laundry shop. The video identification unit 110b in the cloud server can determine types of car washes for different sizes of vehicles including small, medium and large. The video identification unit 110b can determine a type of wash being performed including complete, external, or internal car wash whether the car wash performed together or individually.

In another exemplary first embodiment, the commercial establishment can include a hair salon. The video capturing device 102 can be provided for capturing complete video of the salon. The video identification unit 110b in the cloud server can determine types of services provided for example hair cut, beard shave, sanding, a combination of one or more, or other services.

In an exemplary second embodiment, the commercial establishment can include a restaurant. The video capturing device 102 can be provided for capturing complete video of the restaurant. The video identification unit 110b in the cloud server can identify a beverage served to each customer, number of beverages and quantity of the beverages served to each customer.

In another exemplary second embodiment, the commercial establishment can include a grocery store. The weighing device 105 in the store can measure weight of the meat, fish, vegetables or fruits sold to a customer and transmit to the cloud server 108 for real-time monitoring.

In an exemplary third embodiment, the commercial establishment can include a store selling goods and merchandise including one or a combination of food, clothes, bags, electrical appliances, sanitary materials, building materials, and anything in the form of a commodity, wherein large number of the goods are sold on a daily and regular basis. The point of sale device 104 can transmit the value received from a customer for a bill to the cloud server 108. The product management and planning unit 108 in the cloud server 108 can verify the value received from the customer based on the inventory on a daily basis for real-time monitoring.

The report generation unit 127 can generate daily reports in each of the above exemplary embodiments. The daily report can include daily sales and daily returns, services and/or goods and/or food and beverages that were provided to customer based on the commercial establishment, workers' performance, opening and closing times of the commercial establishment, thefts, frauds that occurred in the commercial establishment, and checks that can be submitted to merchants.

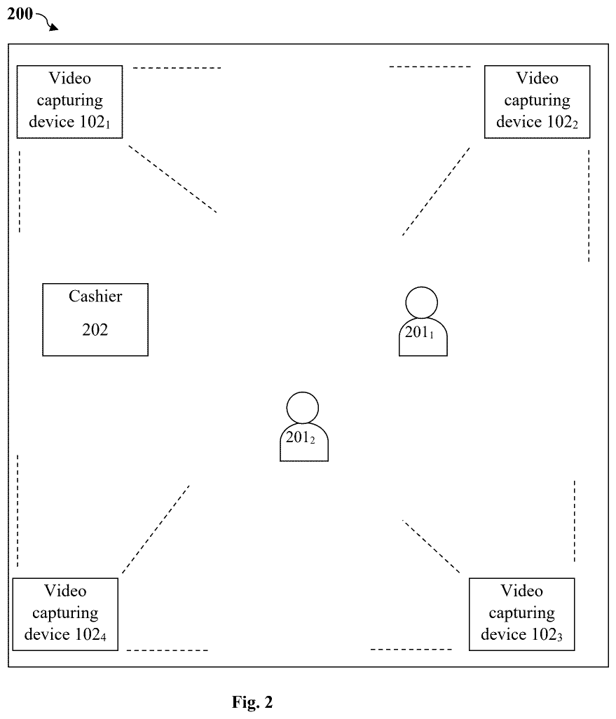

FIG. 2 illustrates a system of monitoring and authenticating a commercial establishment, according to an exemplary embodiment. In an exemplary embodiment, a floor plan of a commercial establishment includes a plurality of video capturing devices 102 placed at multiple positions. The video capturing devices 102 are provided for monitoring employees 201 of the commercial establishment and authenticating transactions performed at cashier 202.

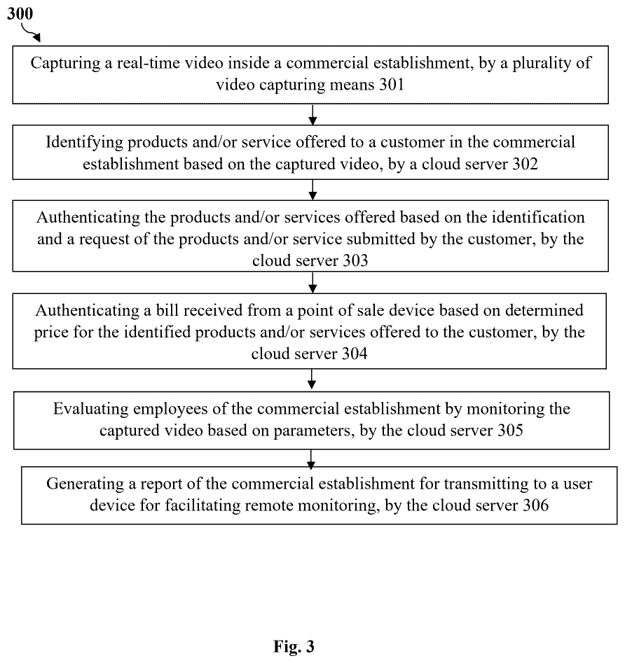

FIG. 3 illustrates a flow chart of a method of monitoring and authenticating a commercial establishment. The method includes but not limited to the following steps. First, capturing 301 a real-time video inside a commercial establishment, by a plurality of video capturing means. Then, detecting request raised by a customer in the commercial establishment, by a detection means. The detection means can include an audio capturing device including microphone. Next, transmitting the captured video and the detected product and/or service to a video monitoring and processing engine in a server. Then, transmitting a bill including the value of the product and/or service offered to the customer to the video monitoring and processing engine, by a point of sale device.

In an embodiment, the video monitoring and processing engine 109 is configured for identifying the product and/or service requested by the customer based on the request detected by the detection means, and identifying 302 products and/or service offered to a customer in the commercial establishment based on the captured video, by a cloud server. Then, the video monitoring and processing engine can determine a value for the identified product and/or service in the request. Next, authenticating 303 the products and/or services offered by comparing with the identified product and/or service requested by the customer. Then, authenticating 304 the value in the bill by comparing with the determined value for the identified products and/or services offered to the customer. Next, evaluating 305 the employees in the commercial establishment by monitoring the captured video, and based on the authentication performed by the authentication unit. Finally, generating a report of the commercial establishment for transmitting to a user device for facilitating remote monitoring, by the cloud server 306.

In an embodiment, an artificial intelligence unit can be configured for updating the identification unit to increase speed of identification based on historical data of identified images of the product and/or service, and identified request from the customer stored in a database.

A main advantage of the present disclosure is that the system and method provides real-time monitoring and authentication of activities of a commercial establishment.

Another advantage of the present disclosure is that the system and method provides real-time monitoring and authentication of activities using video capturing means and image processing.

Still another advantage of the present disclosure is that the the system and method provides a cost-effective monitoring and authentication of activities independent of manual intervention.

Yet another advantage of the present disclosure is that the system and method provides overall automation of activities of a commercial establishment using plurality of video capturing means.

Still another advantage of the present disclosure is that the system and method utilizes artificial intelligence unit for faster and accurate monitoring and authentication of activities of a commercial establishment.

Yet another advantage of the present disclosure is that the system and method can impart safety to the working of the commercial establishment by facilitating remote monitoring.

Still another advantage of the present disclosure is that the system and method can perform real time monitoring of working hours and performance of employees.

Yet another advantage of the present disclosure is that the system and method can monitor financial fraud committed by employees, monitor thefts committed by customers, and monitor the storage in the commercial establishment.

Still another advantage of the present disclosure is that the system and method can generate daily and yearly reports for the commercial establishment facilitating remote monitoring, and monitoring or preventing events including money laundering, escaping tax payments, manipulating price of products and theft, identifying illegal workers, thieves, other criminals, and ensuring the commercial establishment follows rules and regulations.

Yet another advantage of the present disclosure is that the system and method can benefit the government by monitoring the establishments thereby assisting in cases of tax evasion, commercial concealment, money laundering, and price manipulation from the commercial establishments.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A system for monitoring an establishment, comprising:
a plurality of video capturing units (102) for capturing video of the establishment;
a detection means (103) for detecting request raised by a customer in the establishment;
a point of sale device (104) generating a bill including the value of the product and/or service offered to the customer;
a server (108) in communication with the video capturing units (102), the detection means (103), and the point of sale device (104);
wherein the server (108) including a video monitoring and processing engine (109);
wherein the video monitoring and processing engine (109) including:
an identification unit (110) configured to identify the product and/or service based on the detected request received from the detection means,
the identification unit (110) configured to identify the product and/or service offered to the customer based on the captured video,
a determination unit (112) configured to determine a final value for the identified products and/or services offered to the customer,
an authentication unit (115) configured to authenticate the product and/or service offered by comparing with the identified product and/or service requested,
the authentication unit (115) configured to authenticate the value in the generated bill by comparing with the determined value, and
an employee evaluation unit (120) configured to evaluate an employee based on the authentication performed by the authentication unit (115).

2. The system as claimed in claim 1, wherein the detection means (103) including an audio capturing device (103a) for capturing audio of the request raised by the customer.

3. The system as claimed in claim 1, wherein the determination unit (112) configured to determine the final value based on value of each of the identified product and/or service stored in a database (122) and pre-defined parameters for the product and/or service stored in the database (122), wherein the pre-defined parameters including time of service, employee offering the service, duration of service, employee offering the product and/or service.

4. The system as claimed in claim 1, wherein the video monitoring and processing unit (109) including an employee monitoring unit (119), wherein the employee monitoring unit (119) configured to
detect employees from the captured video, and
identify characteristics of the detected employees from the captured video,
wherein the characteristics including movement of the employee, number of sales made by the employee, value of the products and/or services handled by the employee, number of customer interactions.

5. The system as claimed in claim 4, wherein the employee evaluation unit (120) evaluating the employee based on the identified characteristics received from the employee monitoring unit (119) and the authentication received from the authentication unit (115).

6. The system as claimed in claim 1, wherein the database (122) configured to store:
a plurality of images of the products and services offered by the establishment; and
pre-defined variables of the services for facilitating identification, wherein the variables including duration of service, output of service.

7. The system as claimed in claim 6, wherein the identification unit (110) configured to:
identify products offered to the customer by image processing of the captured video and comparing with images stored in the database, and
identify services offered to the customer by identifying the variables in the captured video.

8. The system as claimed in claim 1, wherein the video monitoring and processing engine (109) including:
a database (122) configured to store output received from the identification unit (110), determination unit (112), authentication unit (115), and employee evaluation unit (120), and
an artificial intelligence unit (121) configured to update the identification unit (110) to increase speed of identification based on the identified images of the product and/or service, and the identified audio of the request from the customer stored in the database.

9. The system as claimed in claim 1, wherein the video monitoring and processing engine (109) including a product management and planning unit (111), wherein the product management and planning unit (118) configured to:
include inventory of the products and/or services of the establishment, and update the inventory based on the products and/or services offered to the customer.

10. The system as claimed in claim 1, wherein the request including a list of products and/or services, quantity of products, duration of service.

11. The system as claimed in claim 1, wherein a weighing device (105) configured to transmit a measured weight of the product offered to the customer, and wherein the authentication unit (115) authenticating the measured weight based on quantity of the product detected in the request raised by the customer.

12. The system as claimed in claim 1, wherein the server (108) is a cloud server communicating with the video capturing device (102), detection means (103), point of sale device (104) through a communication network (107), and
the communication network (107) including Wi-Fi.

13. The system as claimed in claim 1, wherein a user device (123) connected to the server (108) through a communication network (107), and
wherein the user device (123) configured to facilitating remote access to the video monitoring and processing engine (109) for monitoring employees of the establishment.

14. The system as claimed in claim 4, wherein a report generation unit (127) is provided for generating a daily report based on the generated bills received from the point of sale device (104), data received from the employee monitoring unit (119), and data received from the employee evaluation unit (120); and
wherein the daily report including:
number and quantity of the products and/or services sold to the customer, and value and mode of the payment received from the customer based on the plurality of generated bills,
amount of working and non-working time of the employees, and entry time and exit time of the employees based on the data from the employee monitoring unit (119), and
performance of the employees for the day based on the data from the employee evaluation unit (120).

15. The system as claimed in claim 14, wherein the report generation unit (127) transmitting the daily report to a user device (123) for facilitating remote monitoring of the establishment.

16. A method for monitoring an establishment, comprising the steps of:
capturing video of the establishment, by a plurality of video capturing means;
detecting request raised by a customer in the establishment, by a detection means;
transmitting the captured video and the detected product and/or service to a video monitoring and processing engine (109) in a server (108),
transmitting a bill including the value of the product and/or service offered to the customer to the video monitoring and processing engine (109), by a point of sale device;
wherein the video monitoring and processing engine (109) configured for:
identifying the product and/or service requested by the customer based on the request detected by the detection means,
identifying the product and/or service offered to the customer based on the captured video,
determining a value for the identified product and/or service in the request, authenticating the product and/or service offered by comparing with the identified product and/or service requested,
authenticating the value in the bill by comparing with the determined value, and evaluating the employee based on the authentication performed by the authentication unit (115).

17. The method as claimed in claim 16, wherein an artificial intelligence unit (120) configured for updating the identification unit to increase speed of identification based on historical data of identified images of the product and/or service, and identified request from the customer stored in a database.

18. The method as claimed in claim 16, wherein the method including generating (306) a report of the establishment for transmitting to a user device for facilitating remote monitoring, by the cloud server.
